(19) United States
(12) Patent Application Publication
(10) Pub. No.: US 2026/0271917 A1
(43) Pub. Date: Sep. 17, 2026

(54) Ultrasound-Assisted Isoparaffinic Oil Nano-Emulsion for Enhanced Agricultural Crop Protection

(71) Applicant: KATA CIRCULAR PTE. LTD., Singapore (SG)

(72) Inventors: Fernando R. de Tezanos, Guatemala City (GT); Matias R. de Tezanos, Guatemala City (GT)

(21) Appl. No.: 19/078,913

(22) Filed: Mar. 13, 2025

(51) Int. Cl. A01N 25/04; A01P 3/00; A01P 7/04

(52) U.S. Cl. CPC A01N 25/04; A01P 3/00; A01P 7/04

(57) ABSTRACT

An agricultural spray formulation and related methods of preparation utilizing specific oil phase components in combination with an engineered surfactant system to achieve enhanced stability and performance characteristics. The formulation exhibits controlled phase behavior and droplet architecture through precision manufacturing protocols, resulting in a stable nano-emulsion system particularly suited for agricultural applications. Implementation of ultrasonic processing parameters enables achievement of targeted physical properties while maintaining formulation integrity across varying environmental conditions. The resultant composition demonstrates superior surface interaction dynamics and enhanced retention characteristics compared to conventional agricultural spray preparations, while reducing required application volumes through optimized delivery mechanisms.

N/A.

### FIELD

This disclosure pertains to the field of agricultural spray oil preparations produced from a sustainable isoparaffinic base oil using ultrasound-assisted emulsification technology to create finely dispersed emulsion droplets for optimized coverage and crop protection efficacy.

### BACKGROUND

As global food demand increases with population growth, agriculture faces mounting pressure to improve productivity and ensure crop safety. Among the critical challenges are pests and diseases that can significantly impair or destroy crop yields. Various protective technologies have emerged, with mineral oil spraying being a widely adopted approach. Saturated paraffinic oils are particularly valuable due to their low polarity, which minimizes plant interaction while providing insecticidal and fungistatic properties through surface film formation. The effectiveness of these oils depends directly on surface area coverage, making smaller droplet sizes desirable for enhanced protection.

However, pure mineral oil applications carry prohibitive costs for agricultural use. The industry has adapted by utilizing emulsions combining mineral oil with water and emulsifiers. This approach not only reduces costs but also enables incorporation of additional agricultural agents in the aqueous phase. Current emulsion technologies face limitations in stability, coverage effectiveness, and environmental impact.

The use of oils for crop protection dates back to the 18th century. Agricultural spray oils are widely used in modern agriculture and there exists extensive knowledge regarding preparation of such products. Petroleum oil along with a variety of emulsifiers and their combinations have been used to manufacture the spray oils for agricultural applications. For instance, U.S. Pat. No. 3,982,920 describes soluble oil preparations that can form stable emulsions with water by gentle shaking. U.S. Pat. No. 4,531,965 discloses a weed control composition containing a mineral oil and adjuvant such as an emulsifier. U.S. Pat. No. 4,440,561 describes the use of white mineral oils in such products. U.S. Pat. Nos. 6,515,031 and 6,673,360 describe technique for emulsifying highly saturated hydroisomerized hydrocarbons using an emulsifier blend that includes ethoxylated C10-C16 alcohols having at least 2.8 ethoxy groups per chain and a glycerol mono- and/or dioleates, preferably in a ratio of from 9:1 to 4:6. These emulsion blends are claimed to be particularly useful when mixed with hydroisomerized oils and water, for subsequent application as a spray oil to agricultural crops. EP1883297 describes preparation of an agricultural spray oil by emulsifying hydroprocessed highly paraffinic oil using C16-C18 alcohol polyglycol ethers as emulsifiers. The preparation is claimed to have good emulsion stability in varying hardness of water, is eco-friendly and highly bio-degradable, non-toxic to humans and non-phytotoxic to plants, and at the same time is highly efficient in controlling plant diseases.

Oil-in-water emulsion-based products are ubiquitous in food, cosmetics, pharmaceuticals, metalworking, and agricultural chemicals. Various emulsion systems are widely applied in the industry. For instance, high pressure emulsifiers allow very small particle sizes to be obtained, namely of the order of 200 nm or even less. High intensity ultrasound (HIU) emulsification is another technique that attracts much attention because it is considered to be eco-friendly and cost-effective.

The acoustic cavitation phenomenon induced by HIU devices can boost the disruption of oil droplets, facilitating the formation of stable emulsions [Trends in Food Science & Technology, Volume 105, November 2020, Pages 363-377]. In the agri-food sector, the use of waves of ultrasonic frequencies was proposed for example for preparing nano-emulsions in an article entitled “The use of ultrasonics for nano-emulsion preparation” by S. Kentisch et al. (Innovative Food Science and Emerging Technologies 9 (2008) 170-175). The method described uses an ultrasonic transducer with a frequency of 20 to 24 kHz. The O/W emulsion obtained has an average droplet size of the order of 135 nm using a mixture of linseed oil and water, in the presence of a surfactant. Further, CN101790978B demonstrates the preparation of pesticide emulsion using ultrasonic emulsification.

As can be seen from the prior art that a large number of combinations of petroleum oils and emulsifiers have been used for making spray oils. However, detailed evaluations of the efficacy of said products depending on the preparation method and the type of the base oil for different crops are rather scarce.

FIG. 1 illustrates a graph 100 depicting molecular configurations of linear alkyl chains varying in length from n=13 to n=21 carbon atoms, with specific emphasis on spatial arrangements and end-to-end molecular distances. The figure presents a systematic array of molecular structures wherein each horizontal row represents a distinct alkyl chain length, progressing from shorter to longer configurations in descending order. Each molecular structure is depicted with explicit carbon-carbon bond arrangements, showing both atomic positions and bond angles characteristic of saturated hydrocarbon chains.

The right-hand axis displays end-to-end molecular distances measured in nanometers, ranging from approximately 1.7164 nm for the shortest chain (n=13) to 2.7416 nm for the longest chain (n=21). A critical structural parameter, identified as the segment separation distance d, is quantified as 0.12814 nanometers, representing the characteristic spacing between adjacent molecular segments.

The molecular geometries are presented in a standardized projection format, with carbon atoms depicted as black nodes and hydrogen atoms as grey spheres. The linear progression of end-to-end distances, indicated by the dotted red line, demonstrates the systematic dimensional increase corresponding to each additional carbon unit in the molecular chain.

This structural analysis, derived from work by N.O.B. Lüttschwager and M. A. Suhm (Soft Matter, 2014, 10, 4885-4901), provides fundamental insights into molecular dimensionality and spatial arrangements relevant to surfactant behavior in emulsion systems.

The volume of oil in the drop decreases rapidly with decreasing the drop diameter, V=⅙πd³. Thus, for 1 μm drops (d=106 m), the oil volume is approx. 5×10⁻¹⁹ m³, and for 0.1 um (micrometer) drops (d=10⁻⁷ m), the oil volume is 5×10⁻²² m³. The volume of surfactant will πLd², i.e., 6×10⁻²¹ m³ for 1 μm drops, and 6×10⁻²³ m³ for 0.1 μm drops. It will be understood that for 1 μm drops, the volume of adsorbed surfactant accounts for approx. 1% of the total drop volume, but for 0.1 μm drops, the volume of adsorbed surfactant accounts already for approx. 10% of the overall drop volume. It is well known that surfactant is partitioned between the bulk and the interface—the corresponding partitioning coefficient is described by the so-called adsorption isotherm. Different surfactants have different affinity to the interface and different solubility in oil and water. Therefore, the smaller the desired drop size, the higher surfactant-to-oil ratio in soluble oil formulation is required.

It will be understood that different classification rules may apply depending on the industry. For example, for metalworking fluids, ISO 6743/7 classification is used which defines three categories of emulsions: (i) milky emulsions comprising the L-MAA (Emulsifiable oils with high mineral oil content), L-MAB (Emulsifiable oils with medium mineral oil content), L-MAC (Emulsifiable oils with low mineral oil content) and L-MAD (Emulsifiable oils with very low mineral oil content) classes as per, (ii) microemulsions—the classes L-MAE (Microemulsions with high mineral oil content) and L-MAF (Microemulsions with low mineral oil content), and (iii) synthetic fluids—the classes L-MAG (Microemulsions with varying mineral oil content) and L-MAH (Synthetic fluids that are oil-free, with L-MAH formulated for heavy-duty use). Traditional “milky” emulsions contain 1 to 10% surfactant, and microemulsions contain 10 to 50% surfactant. The so-called micellar solutions contain only surfactants and water, without any oil.

One important characteristic of a surfactant or surfactant mix used in the formulations described herein is its hydrophilic-lipophilic balance (HLB) value. The HLB of a surfactant is a measure of its degree of hydrophilicity or lipophilicity, determined by calculating percentages of molecular weights for the hydrophilic and lipophilic portions of the surfactant molecule. Low HLB surfactants are oil soluble and high HLB surfactants are water soluble.

Referring now to FIG. 2, which illustrates a graphic representation 200 of different base oils showing different polarities. For instance, naphthenic oils are more polar than isoparaffinic oils, which can be traced back to differences in the aniline point. Therefore, it is useful to fine-tune the emulsifier to the type of the base oil used. One convenient formulation technique is to bracket the optimal HLB value by two surfactants, one with a higher than optimal HLB value, and the other one, with a lower than optimal HLB value. Then, by mixing such two surfactants in different ratios, the optimal HLB value for emulsifying a certain base oil type can be easily found from experiments.

Unlike soluble oil formulations used in metalworking, which always contain some excess of emulsifier to accommodate different degrees of dilution, typically from 2 to 10%, soluble oils used for agricultural crop protection are required to have the minimum amount of surfactant to minimize wash off of oil by rain. Therefore, the production of stable emulsions is more challenging, as conventional stirring does not provide sufficient shear forces to break larger drops into smaller ones. After an oil drop gets solubilized, the oil drop surface is covered by a layer of surfactant, and a substantial part emulsifier stays unused having being effectively incapsulated in the oil phase.

### SUMMARY

According to some embodiments, the present disclosure is directed to an agricultural spray formulation. The agricultural spray formulation also includes an oil phase, the oil phase may include isoparaffinic hydrocarbon oil, substantially free of naphthenic compounds. The formulation also includes an aqueous phase, the aqueous phase may include treated water. The formulation also includes a surfactant phase, the surfactant phase may include: 0 to 5 percent by mass of a fatty alcohol ethoxylate, may include lauric alcohol ethoxylates containing seven to nine ethylene oxide units, with a hydrophilic-lipophilic balance value of 12 to 14; 0 to 5 percent by mass of sorbitan monooleate with a hydrophilic-lipophilic balance value of 4 to 5, and 0 to 5 percent by mass of polyoxyethylene twenty sorbitan monolaurate, with a hydrophilic-lipophilic balance value of 16 to 17. The formulation also includes the formulation may include a nano-emulsion having a mean droplet size of 10 to 100 nanometers, with a monomodal droplet size distribution, and demonstrating stability against phase separation under ambient conditions.

Implementations may include one or more of the following features. The agricultural spray formulation where the isoparaffinic hydrocarbon oil may include 30.0 to 35.0 percent by mass of the formulation. The aqueous phase may include 60.0 to 70.0 percent by mass of the formulation. The treated water of the aqueous phase has a conductivity of less than 10 microsiemens per centimeter and a pH between 5.0 and 6.5. The nano-emulsion may include: a first rheological state may include non-Newtonian shear-thinning behavior when the hydrocarbon oil exceeds 20 percent by mass, providing storage stability; a second rheological state may include Newtonian behavior when diluted to less than 10 percent by mass hydrocarbon oil content, enabling uniform spray distribution; and a third rheological state may include thixotropic properties upon water evaporation after application, enhancing retention on plant surfaces. The nano-emulsion demonstrates a droplet coverage density of at least 60 droplets per square centimeter when applied to crop surfaces. The nano-emulsion exhibits a brix grade of 30.0 to 42.0 percent at 20 degrees Celsius. The agricultural spray formulation may include 0.1 to 10.0 percent by mass of an agricultural active ingredient selected insecticides and/or fungicides.

According to some embodiments, the present disclosure is directed to a process for preparing an agricultural spray oil nano-emulsion. The process also includes combining treated water, an isoparaffinic hydrocarbon oil, and a surfactant mixture in a mixing chamber to form a pre-emulsion, the surfactant mixture may include: a fatty alcohol ethoxylate containing seven to nine ethylene oxide units with a hydrophilic-lipophilic balance value of 12 to 14. The process also includes sorbitan monooleate with a hydrophilic-lipophilic balance value of 4 to 5. The process also includes polyoxyethylene twenty sorbitan monolaurate with a hydrophilic-lipophilic balance value of 16 to 17. The process also includes subjecting the pre-emulsion to ultrasonic energy under the following conditions: a frequency of approximately 20 kilohertz, a sonic wave power density in excess of 10 watt per liter, a total energy input of 0.5 to 50 watt-hours per liter, and a processing temperature maintained below 45 degrees Celsius. The process also includes continuing ultrasonic processing until a nano-emulsion is formed with a mean droplet size of 10 to 100 nanometers and a monomodal droplet size distribution, and resisting phase separation under ambient conditions. Other embodiments of this aspect include corresponding computer systems, apparatus, and computer programs recorded on one or more computer storage devices, each configured to perform the actions of the methods.

Implementations may include one or more of the following features. The process where the treated water has a conductivity of less than 10 microsiemens per centimeter and a pH between 5.0 and 6.5. The nano-emulsion may include 30.0 to 35.0 percent by mass of the isoparaffinic hydrocarbon oil. The nano-emulsion may include 60.0 to 70.0 percent by mass of the treated water. The nano-emulsion achieves comparable or improved pest and disease control efficacy while including at least 30 percent less oil per hectare compared to emulsions prepared without ultrasonic processing. The nano-emulsion may include: a concentrated state having non-Newtonian rheological properties with a viscosity between 19.0 and 27.0 centipoise at 25 degrees Celsius; a diluted state for application having substantially Newtonian rheological properties with a viscosity between 5.0 and 8.0 centipoise at 25 degrees Celsius; and where the nano-emulsion transitions from the Newtonian diluted state to a thixotropic state upon partial water evaporation during the forming of the uniform coating on the crop surfaces. The nano-emulsion demonstrates a droplet coverage density of at least 60 droplets per square centimeter when applied to crop surfaces. Implementations of the described techniques may include hardware, a method or process, or computer software on a computer-accessible medium.

According to some embodiments, the present disclosure is directed to a method of using an agricultural spray oil nano-emulsion for crop protection. The method also includes obtaining a nano-emulsion, the nano-emulsion may include: an oil phase, the oil phase may include an isoparaffinic hydrocarbon oil; an aqueous phase, the aqueous phase may include water; a surfactant mixture, the surfactant mixture may include a fatty alcohol ethoxylate containing seven to nine ethylene oxide units, sorbitan monooleate, and polyoxyethylene twenty sorbitan monolaurate, the nano-emulsion has a mean droplet size of 10 to 100 nanometers and a monomodal droplet size distribution. The method also includes applying the nano-emulsion to crops at an application rate of 10 to 30 liters per hectare using a spraying device configured to deliver droplets with a size distribution between 10 and 100 nanometers. The method also includes forming a uniform coating on crop surfaces.

Implementations may include one or more of the following features. The method where the forming of the uniform coating may include: applying the nano-emulsion in a Newtonian state having a viscosity between 5.0 and 8.0 centipoise; allowing partial water evaporation during droplet transit to induce shear-thinning behavior; achieving surface adhesion through transformation to a thixotropic state upon plant contact; and where the thixotropic state provides: resistance to rainfall wash-off; enhanced spreading across hydrophobic leaf surfaces; and mechanical stability against wind-induced removal. The nano-emulsion further may include 0.1 to 10.0 percent by mass of an agricultural active ingredient selected from the group may include of insecticides and fungicides. The uniform coating demonstrates a droplet coverage density of at least 60 droplets per square centimeter. The nano-emulsion achieves comparable or improved pest and disease control efficacy while including at least 30 percent less oil per hectare compared to applications prepared without ultrasonic processing.

### BRIEF DESCRIPTION OF THE DRAWINGS

FIG. 1 illustrates molecular configurations of linear alkyl chains varying in length, with end-to-end molecular distances and spatial arrangements depicted.

FIG. 2 presents a comparison of base oil polarities, distinguishing between naphthenic and isoparaffinic oils, and demonstrating emulsification characteristics based on hydrophilic-lipophilic balance (HLB) values.

FIG. 3 depicts the structural transformation of emulsions from conventional architectures to supercritical nano-emulsions achieved via ultrasonic processing, emphasizing optimized surfactant utilization and reduced droplet size.

FIG. 4 provides comparative droplet size distribution profiles, highlighting the superior dimensional uniformity of supercritical nano-emulsions relative to conventional “milky” emulsions.

FIG. 5 illustrates the ATR-FTIR and NMR analysis results of a sustainable isoparaffinic oil, confirming its purity and absence of significant naphthenic or aromatic compounds, and FIG. 6 presents the nuclear magnetic resonance (NMR) spectral characterization of KATA AGRO oil, demonstrating comprehensive molecular structural analysis across the chemical shift domain.

FIG. 7 illustrates quantitative field trial data evaluating surface coverage density and material recovery rates for supercritical nano-emulsion applications under controlled agricultural conditions.

FIG. 8 illustrates quantitative field trial results for a conventional emulsion preparation, focusing on leaf coverage density and material recovery rates under controlled agricultural conditions.

FIG. 9 and FIG. 10 each illustrate photomicrographic analyses of hydrosensitive card data, demonstrating uniform droplet deposition and size distribution achieved with the supercritical nano-emulsion formulation.

FIG. 11 illustrates schematic of the raw material processing system, detailing the handling of isoparaffinic oil, treated water, and surfactants, and their integration into a centralized ultrasonic processing system.

FIG. 12 illustrates an example computer system for controlling ultrasonic processing, material flow, and environmental conditions to ensure consistency in nano-emulsion production.

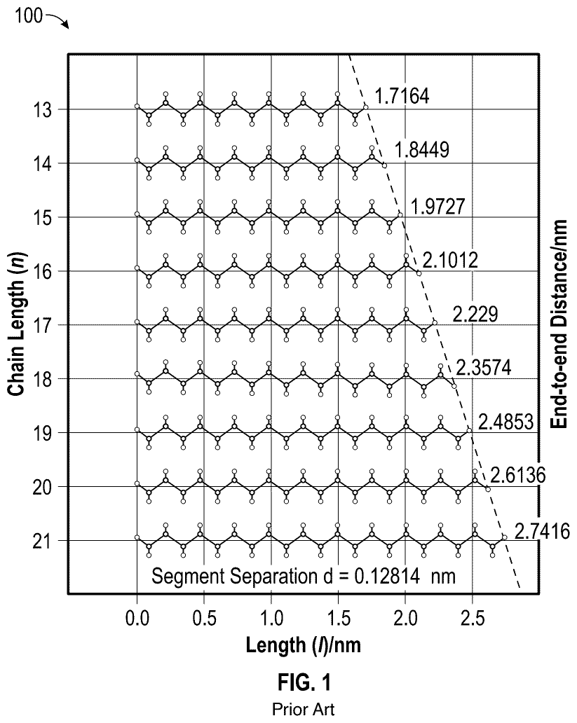

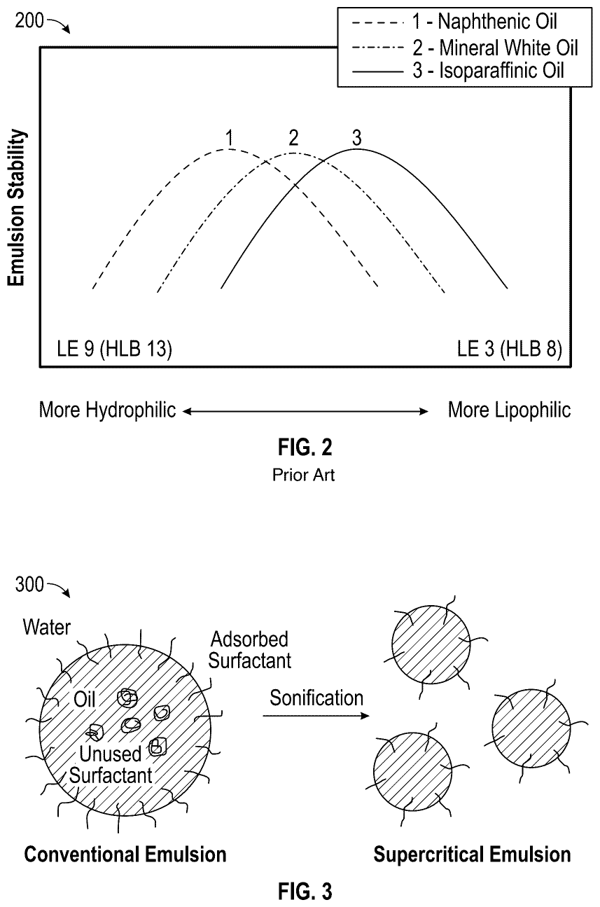

### DETAILED DESCRIPTION OF EXAMPLE EMBODIMENTS

### Overview

The present disclosure pertains to formulations such as an oil-in-water nano-emulsion, offering enhanced effectiveness, environmental compatibility, and versatility. Example formulations comprise isoparaffinic hydrocarbon oil, non-ionic surfactants, and purified water, resulting in a stable emulsion suitable for pest and disease control.

An example method uses ultrasonic-assisted processing to achieve nano-sized droplets, increasing surface area coverage and extending residence time on crop surfaces. The process utilizes high-energy sonication to reduce droplet size to levels not attainable with conventional homogenization techniques, while maintaining emulsion stability and functionality. This ultrasonic process is carried out under controlled parameters to ensure thermal stability of the components.

The stability of the emulsion is further achieved through a specific combination of surfactants, including alcohol ethoxylates, sorbitan esters, and ethoxylated sorbitan esters. These surfactants, selected based on their hydrophilic-lipophilic balance (HLB), work synergistically to stabilize the emulsion and provide consistent performance under various conditions. The formulation is environmentally friendly and biodegradable.

This composition is adaptable and can incorporate additional agrochemical agents, such as pesticides or nutrients, without compromising its stability or performance. The flexibility in ingredient ratios allows tailoring to specific crop needs and agricultural conditions.

### Example Embodiments

The present disclosure demonstrates the use of a sustainable isoparaffinic oil produced from waste plastic for agricultural spray oil preparations. One example advantage of using a sustainable base oil is its lower carbon footprint and lower phytotoxicity compared to traditional formulations. Sonic emulsification has been used to prepare supercritical emulsions that require less emulsifier than conventional preparations.

Spray oil preparations produced according to the present disclosure demonstrate superior efficacy compared to other competing products while greatly reducing the oil demand per hectare. In the field trials, emulsions produced according to the present disclosure demonstrated leaf retention up to 80%, whereas traditional formulations never exceed 60 to 70% retention. With a typical spray rate of around 20 liters per hectare, this will give substantial cost savings, taking into account that the total area of farmland in Latin America amounts to over 600 million hectares.

In the context of the present disclosure, supercritical emulsions are defined as the emulsions that use the minimum possible amount of emulsifier to ensure emulsion stability at a given drop size. Alternatively, supercritical emulsions can be defined as stable emulsions with minimum droplet size possible to achieve for the given amount of emulsifier in the formulation. Due to differences in specific gravity of water and oil, oil tends to skim at the surface. By reducing the oil droplet size, one can reduce the tendency for skimming but at the same time the demand for emulsifier increase. The minimum amount of emulsifier required to stabilize an emulsion can be deduced by determining a thickness of adsorbed lauryl alcohol ethoxylate surfactant layer stabilizing oil droplets in water is around L=2 nm, or 2×10⁻⁹ m.

Using ultra high shear emulsification via ultrasound sonification or cavitating jet emulsification, supercritical emulsions can be produced that contain virtually no unused surfactant in the oil phase. Such emulsions also have more narrow drop size distribution of approximately 0.1 μm average drop size.

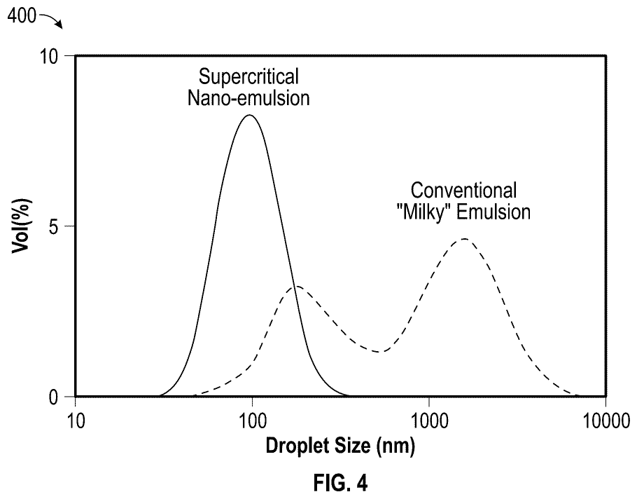

FIG. 3 depicts a comparative illustration 300 demonstrating the structural transformation between conventional and supercritical emulsion architectures through sonification processing. The comparative analysis presents two distinct morphological states of the emulsion system, with specific emphasis on surfactant utilization and droplet configuration characteristics.

In the conventional emulsion architecture, depicted on the left side of the illustration, a singular large-diameter dispersion contains both surface-active molecules positioned at the oil-water interface and unutilized surfactant components retained within the internal oil phase. The interfacial region exhibits characteristic amphiphilic molecular orientation, wherein hydrophilic moieties extend into the aqueous phase while hydrophobic segments maintain orientation toward the oil phase interior.

Upon application of controlled sonification energy, the system undergoes substantial morphological reorganization, resulting in the formation of multiple discrete droplets characterized by significantly reduced diametrical dimensions, designated as the supercritical emulsion state. These resultant formations demonstrate uniform dimensional characteristics while maintaining interfacial surfactant coverage, notably with previously unutilized surfactant molecules now participating in interface stabilization functions.

The supercritical emulsion morphology exhibits several distinguishing characteristics, including optimized surfactant distribution across all formed interfaces, elimination of entrapped unutilized surfactant within the oil phase, achievement of uniform droplet size distribution parameters, enhanced interfacial stabilization mechanisms, and overall reduction in total system volume.

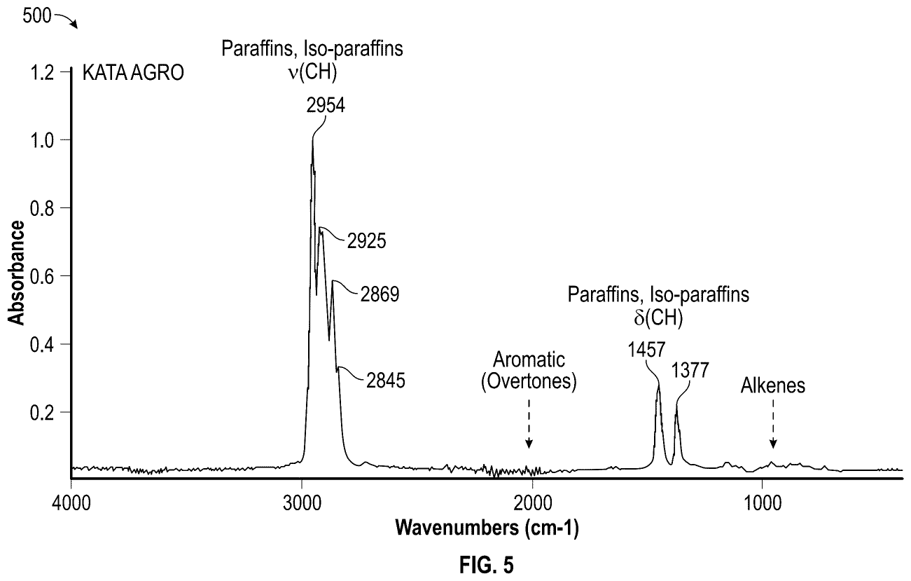

FIG. 4 presents comparative droplet size distribution profiles 400 characterizing the dimensional architectures of supercritical nano-emulsions and conventional “milky” emulsions. The graphical representation depicts droplet volume percentage (VOL %) as a function of droplet size measured in nanometers (nm), utilizing a logarithmic scale spanning from 10 to 10,000 nanometers.

The supercritical nano-emulsion, represented by a solid line, exhibits a singular, well-defined peak centered approximately at 100 nanometers, characterized by a narrow distribution profile and enhanced volume percentage reaching approximately 8%. This monomodal distribution demonstrates precise dimensional control achieved through optimized processing parameters.

In contrast, the conventional “milky” emulsion, depicted by a dashed line, presents a bimodal distribution with significantly broader dimensional variance. The first peak appears at approximately 100 nanometers with reduced intensity, while a second, broader peak manifests at approximately 2000 nanometers. This bimodal characteristic indicates suboptimal droplet formation and size control inherent to conventional emulsification methodologies.

The comparative analysis demonstrates superior dimensional uniformity achieved through supercritical emulsification protocols, evidenced by the absence of secondary peaks and substantially reduced dimensional variance. This enhanced control over droplet architecture directly correlates with improved formulation stability and application effectiveness.

The quantitative dimensional analysis supports advanced emulsion engineering principles, wherein precise control over droplet size distribution parameters enables achievement of optimal performance characteristics in agricultural spray oil applications.

It is well known that sufficiently concentrated oil-in-water emulsions reveal non-Newtonian rheology (see e.g. H. A. Barnes, Rheology of emulsions—a review, Colloids and Surfaces A: Physicochemical and Engineering Aspects, 91 (1994) 89-95). If the emulsified oil fraction exceeds approximately 20%, a shear-thinning effect can be measured. Oil droplets in surfactant-stabilized emulsions are surrounded by a hydration layer formed by the hydrogen bonding between the polar ends (ethoxylate or sugar units) of surfactant molecules and water molecules. Therefore, the non-Newtonian behavior is especially pronounced in supercritical emulsions according to the present invention as narrow droplet size distribution allows dense droplet packing that promotes associative phenomena.

At the same time, diluted emulsions where oil fraction is below 10% demonstrate a nearly Newtonian behavior. The combination of properties is very important for the intended end-use of the product as agricultural spray oil. First factor is that the concentrated nano-emulsion prepared according to the present invention reveal excellent storage stability due to their “creamy” consistency which prevents oil separation. However, before the actual application by spraying, the original concentrate is diluted by water. The resulting diluted emulsion is easy to spray in a controlled way due its low viscosity and nearly Newtonian behavior. As the excess water evaporates as spray droplets travel to the plants, the oil/water ratio increases and the emulsion regains its thixotropic properties. As a result, the emulsion droplets that hit the leaves of the plant demonstrate excellent retention and virtually no run-off. This is especially beneficial for protecting crops that demonstrate the so-called “lotus effect” when water drops falling onto the leaves can bead up and roll off.

In some embodiments, the preparation of stable oil-in-water nano-emulsions requires specific material selection. The oil phase includes an isoparaffinic hydrocarbon oil substantially free of naphthenic compounds and heteroatoms. Specific attributes of the oil phase can be confirmed through CHNSO elemental analysis, 1H and 13C Nuclear Magnetic Resonance (NMR) and Fourier Transform Infrared (FTIR) analysis. The branched (isoparaffinic) structure minimizes phytotoxicity risks to treated plants. Suitable base oil types include severely hydrotreated and hydroisomerized base oils, gas-to-liquid (GTL) and coal-to-liquid (CTL) base oils, alkylate base oils, and as a preferred option, sustainable base oils produced by waste plastic upcycling, with viscosities from ISO VG 3 to 10. Table 1 illustrates the physicochemical properties of sustainable isoparaffinic oil produced from waste plastic.

TABLE 1

| Property | Method | Value |
|---|---|---|
| KV40, cSt | ASTM D445 | 3.9 |
| KV100, cSt | ASTM D445 | 1.4 |
| Specific gravity @ 15° C., | ASTM D1298 | 0.81 |
| g/cm³ | | |

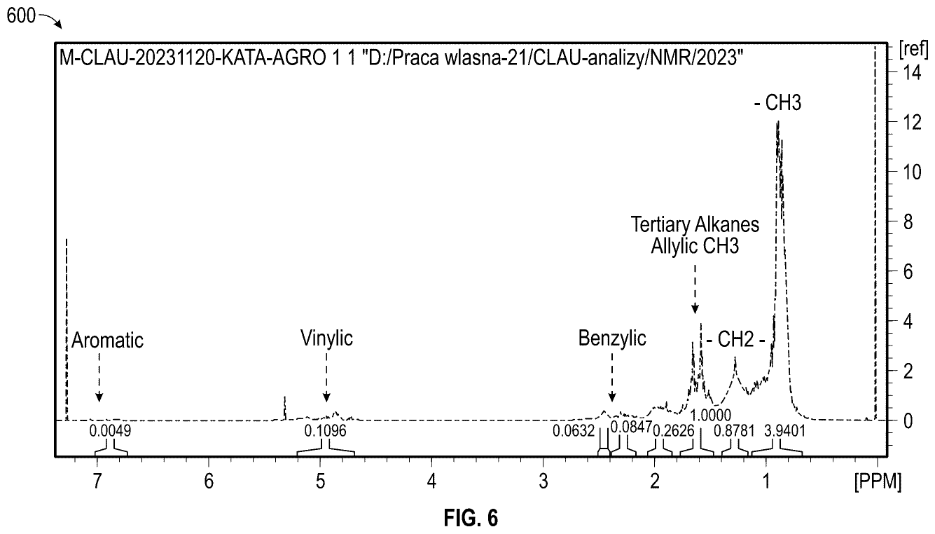

As illustrated in FIG. 5, which includes a graphical representation 500, the ATR-FTIR (Attenuated Total Reflection Fourier Transform Infrared) and NMR (Nuclear Magnetic Resonance) analysis of the oil proves that that this a pure isoparaffinic oil containing only trace amounts of naphthenes and aromatics.

FIG. 6 presents the nuclear magnetic resonance (NMR) spectral characterization 600 of KATA AGRO oil, demonstrating comprehensive molecular structural analysis across the chemical shift domain of 0-8 parts per million (PPM). The spectral acquisition parameters have been optimized to provide high-resolution characterization of hydrocarbon molecular architectures, with particular emphasis on identification and quantification of specific structural moieties.

The spectrum exhibits a series of well-resolved resonance features, with dominant signals characteristic of saturated hydrocarbon structures. The most prominent resonance appears at approximately 0.9 ppm, corresponding to terminal methyl (—CH3) groups, while methylene (—CH2-) resonances manifest at approximately 1.3 ppm. These primary signals demonstrate intensity distributions consistent with predominantly isoparaffinic molecular architecture.

Secondary spectral features include low-intensity resonances in regions characteristic of specific structural elements. Tertiary alkane and allylic methyl signals appear at approximately 1.8 ppm, while minimal benzylic resonances are observed at approximately 2.3 ppm. The spectrum further reveals trace vinylic signals at approximately 4.8 ppm and negligible aromatic resonances in the region of approximately 7.0 ppm, confirming minimal unsaturated and aromatic content.

A first surfactant family comprises fatty alcohol ethoxylates (AE), and in one embodiment lauric alcohol ethoxylates (LAE) containing 7 to 9 ethylene oxide (EO) moieties. Suitable commercial products are manufactured by P&G Chemicals, Clariant, BASF, Akzo Nobel, Huntsman International, Ecogreen Oleochemicals and others. The alcohol ethoxylates provide a range of hydrophile-lipophile balance (HLB) values for optimizing emulsion characteristics.

Additional surfactant families include ethoxylated and non-ethoxylated sorbitan esters. The ethoxylated sorbitan esters, particularly polysorbate 20, provide high HLB values effective for oil-in-water (O/W) emulsion stabilization. Known manufacturers of polysorbates are BASF, Croda, PCC Group, KAO Chemicals, KeanChem, and others, under trade names Kolliphor PS 20, Scattics, Alkest TW 20, Tween 20, Kotilen 20, etc. These materials demonstrate biodegradability and compatibility with agricultural and pharmaceutical applications.

In one specific example, non-ethoxylated sorbitan esters, such as sorbitan monooleate, provide low HLB values effective for water-in-oil emulsion stabilization. Sorbitan monooleate is manufactured by Croda, BASF, Indorama, PCC Group, Stepan, Spell Organics, Univenture, Syskem Chemie, Guangdong Huana Chemical, Chemsino, and others, under names Span 80, Dehymuls SMO, Alkest SP 80, Toximul SEE-341, SMO, and so forth. These materials find broad application in food, cosmetic, and pharmaceutical products. As explained in the background section, the combination of surfactants with complementary HLB values enables formation of stable nano-emulsions with consistent physical properties.

The water or aqueous phase requires specific treatment protocols. An example process includes sequential water treatment steps such as initial softening followed by reverse osmosis filtration to achieve pH between 5.0-6.5 and conductivity below 10 microsiemens per centimeter. These parameters ensure consistent water quality for standardized production and emulsion stability.

The treated water's high purity level prevents destabilization from pH variations and eliminates interference from dissolved salts. This characteristic becomes important when the nano-emulsion serves as a carrier for additional agricultural active ingredients, as the absence of interfering ions provides compatibility with a broad range of agricultural chemicals.

The agricultural spray formulation may further comprise 0.1 to 10.0 percent by mass of an agricultural active ingredient, wherein said agricultural active ingredient is selected from the group consisting of insecticides, fungicides, acaricides, nematicides, bactericides, plant growth regulators, herbicides, molluscicides, algaecides, defoliants, desiccants, chemosterilants, repellents, pheromones, attractants, medicaments, plant nutrients, and combinations thereof. In certain embodiments, the agricultural active ingredient may include systemic compounds capable of being absorbed and translocated within plant tissues, contact compounds that remain substantially on treated surfaces, or combinations thereof. The active ingredients may be incorporated in their pure form, as technical concentrates, or as formulated products. When formulated products are utilized, the active ingredients may be combined with auxiliary substances such as carriers, solvents, surface-active compounds, or other adjuvants that enhance biological efficacy, provided that such auxiliary substances do not materially affect the essential characteristics of the nano-emulsion. The selection and concentration of active ingredients may be optimized based on target organisms, environmental conditions, crop type, and application timing, with the nano-emulsion serving as an optimized delivery system that enhances both initial coverage and sustained biological activity through controlled release characteristics inherent in the emulsion architecture.

As detailed in Table 2, the formulation encompasses a range of concentrations for each component, allowing for tailored adjustments to meet specific application needs. The isoparaffinic oil concentration, for instance, ranges from 20.0% to 60.0% by mass, ensuring flexibility while maintaining emulsion stability.

TABLE 2

| | Isoparaffinic | Sorbitan | Ethoxylated | Alcohol |
|---|---|---|---|---|
| Water | Oil | esters | sorbitan esters | ethoxylate |
| 25.0-80.0% | 20.0-60.0% | 0.0-5.0% | 0.0-5.0% | 0.0-5.0% |

The formulation, expressed in mass percentages, provides formulation flexibility to address varying application requirements. The isoparaffinic oil concentration ranges from 20.0 to 60.0 percent, with preferred concentrations between 30.0 and 50.0 percent, and optimal performance typically achieved between 30.0 and 35.0 percent. The non-ionic surfactants are incorporated at 0.0 to 5.0 percent each, preferably between 1.0 and 2.0 percent, with optimal ranges between 1.0 and 1.5 percent. The total amount of emulsifier ranges from 1 to 10% by mass. In some embodiments, water comprises the balance to 100 percent.

When mixed with different agricultural active ingredients, adjustment of surfactant ratios within the disclosed ranges maintains stability while accommodating the varying chemical properties of different active ingredients. This tailored approach provides optimal performance when the formulation serves as a carrier for commonly used agricultural chemicals from major manufacturers, without compromising the core stability and performance characteristics.

The selected non-ionic surfactant families operate synergistically through complementary HLB values. The ethoxylated lauric alcohol (ALE 9) and polysorbate 20 (Tween 20) provide high HLB values of 13.4 and 16.7 respectively, promoting oil-in-water emulsion stability. In contrast, sorbitan monooleate (SPAN 80) contributes a low HLB value of 4.3, enhancing water-in-oil emulsion characteristics. This combination of surfactants with divergent HLB values facilitates formation and stabilization of nano-scale droplets within the emulsion structure.

In a preferred embodiment, the surfactant mixture comprises precisely controlled proportions of three complementary non-ionic surfactants: (i) 1.0 to 1.5 percent by mass of fatty alcohol ethoxylate, specifically lauric alcohol ethoxylates containing seven to nine ethylene oxide units (HLB 12-14), (ii) 1.0 to 1.5 percent by mass of sorbitan monooleate (HLB 4-5), and (iii) 1.0 to 1.5 percent by mass of polyoxyethylene twenty sorbitan monolaurate (HLB 16-17). This precise tripartite formulation ensures optimal interfacial stabilization through complementary HLB values while maintaining minimal total surfactant content to prevent excessive wash-off during agricultural application. The narrow concentration ranges for each surfactant component have been experimentally determined to provide optimal emulsion stability while facilitating the achievement of the desired nano-scale droplet architecture during ultrasonic processing.

The nano-emulsion, when applied at rates between 10 and 30 liters per hectare using appropriate spraying equipment, produces a uniform distribution of droplets having a size distribution between 10 and 100 nanometers. This correlation between application rate and droplet size distribution has been experimentally validated across multiple field trials and is critical for achieving the desired coverage density of at least 60 droplets per square centimeter. The maintenance of nano-scale droplet dimensions during the spraying process is facilitated by the specific surfactant composition and concentrations detailed above, which provide sufficient interfacial stabilization to prevent droplet coalescence during transit while enabling optimal spreading behavior upon plant surface contact.

The nano-emulsion preparation involves a specific sequence of mixing and processing steps. First, water, isoparaffinic oil, and emulsifiers are pre-mixed using vigorous agitation at room temperature. Due to its high pour point, the ethoxylated lauric alcohol (ALE 9) requires preheating to 40 degrees Celsius to ensure proper solubilization. After that, the mixture is subjected to sonification.

In one embodiment, the mixture is continuously circulated through an ultrasonic processor chamber for enhanced component dispersion. The ultrasonic processor operates at 1500-2000 watts, typically 1800 watts, with energy transmitted via a piezoelectric sonotrode vibrating at 20 kilohertz frequency. The typical volume of the mixture being processed is around 3000 L, and the flow rate 40 to 80 liters per minute, and the total processing time is 10 to 20 hours. During the process, 15,000 to 40,000 watt-hours of energy is supplied to the system, meaning the energy demand of 5 to 15 watt-hours per liter. The sonic energy is being pumped into the mixture within the sonotrode chamber with the minimum sonic power density in excess of 10 watt per liter, and preferably in excess of 100 watt per liter for efficient emulsification in a flow-through process. The process output can be easily scaled up or down using sonotrodes with different power and flow rate. For example, using a sonotrode with 3,600 Watts of power instead of 1,800 Watts of power, one can double the flow rate and either halve the processing time or double the volume of the mixture being processed.

High-frequency sonotrode movement produces significantly smaller droplet sizes compared to conventional emulsion homogenization methods. While the sonification process generates heat, temperature control is critical as each component has a specific degradation threshold—the temperature at which the material begins to chemically or physically degrade. For the surfactants used in this system, temperatures above 45 degrees Celsius can cause decomposition or loss of emulsification properties. Similarly, the isoparaffinic oil components may undergo undesired chemical changes above this temperature. Therefore, maintaining temperature below 45 degrees Celsius through a water-cooled jacket system prevents thermal degradation of both the individual components and the resulting nano-emulsion system. After achieving the desired energy input, the processed nano-emulsion transfers to containers for quality control evaluation.

The ultrasonic processing generates initial droplet formation, but long-term stability may depend on emulsifier composition. Extensive testing of surfactant combinations revealed that stable nano-scale droplets require both proper ultrasonic processing parameters and specific emulsifier ratios. The combination of precise ultrasonic energy input and optimized surfactant selection enables formation of stable droplets at sizes difficult to achieve through conventional methods.

There are a number of commercial techniques suitable for sonic-assisted emulsification according to the present invention. These include but are not limited to jet cavitators, such as DynaSwirl® Cavitating Swirling Jets from DynaFlow Inc., SL-series of cavitation jet machines (Zhongsen Huijia Technology, Beijing, China), and CCBL jets (GQOil, Poland), and ultrasonic emulsifiers manufactured by Hielscher, Putsonic, Hangzhou Altrasonic, etc.

Field testing conducted across multiple continents demonstrated significant economic and environmental advantages through reduced oil consumption. The formulation achieves equivalent or superior crop protection while utilizing approximately 60% less oil compared to conventional treatments. This reduction in oil usage, combined with the enhanced stability and performance characteristics, provides substantial benefits to agricultural operations without compromising effectiveness.

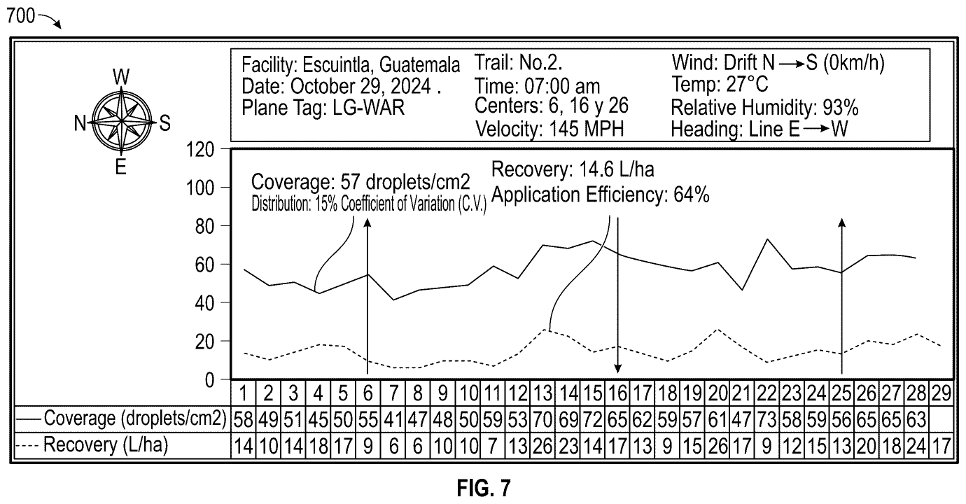

FIG. 7 illustrates quantitative field trial data demonstrating application efficacy parameters for supercritical nano-emulsion deployment under controlled agricultural conditions, in the form of a graph 700. The trial was conducted at Escuintla, Guatemala facility utilizing precision aerial application methodologies, with environmental parameters maintained at 27° C. temperature and 93% relative humidity under minimal wind conditions (derived N→S at 0 km/h).

The graphical representations depict dual-parameter tracking across 29 measurement intervals, monitoring both surface coverage density (measured in droplets per square centimeter) and material recovery rates (measured in liters per hectare). The coverage density profile, indicated by the upper trace, demonstrates consistent droplet distribution averaging 57 droplets per square centimeter with a coefficient of variation of 15%, validating uniform application characteristics.

Material recovery rates, represented by the lower trace, exhibit a mean value of 14.6 L/ha with an application efficiency coefficient of 64%. The deployment parameters were maintained at 145 MPH aerial velocity with specific focus on centers 6, 16, and 26 for detailed analytical assessment, as indicated by the vertical assessment markers.

The integrated data set confirms achievement of optimal coverage metrics while maintaining efficient material utilization rates, demonstrating superior performance characteristics of the supercritical nano-emulsion formulation under field deployment conditions. The achieved coverage density and recovery parameters support enhanced leaf retention capabilities, with measured retention values averaging 79% across the trial duration.

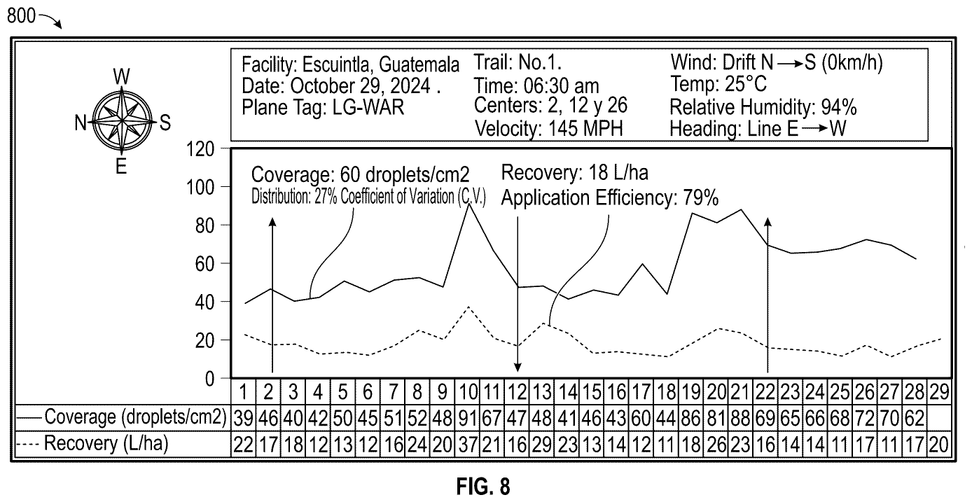

FIG. 8 illustrates the field trial results for a conventional emulsion preparation, focusing on leaf coverage density and material recovery rates under controlled agricultural conditions, in the form of a graph 800. The trials were conducted at the Escuintla, Guatemala facility, with environmental parameters including a temperature of 25° C., relative humidity of 94%, and wind drift conditions of zero (N→S, 0 km/h). The application was performed at an aerial velocity of 145 MPH, with data collected over 29 intervals.

The graph demonstrates leaf coverage density, expressed in droplets per square centimeter, with an average value of 57 droplets/cm² and a coefficient of variation of 27%. The coverage profile reveals noticeable inconsistencies, with periodic spikes and troughs indicative of non-uniform droplet distribution across the treated area. This variability highlights the limitations of conventional emulsions in achieving consistent deposition, particularly under fluctuating application conditions.

Material recovery rates, measured in liters per hectare, averaged 18 L/ha, with observed deviations across the sampling intervals. While the overall recovery rate is indicative of acceptable efficiency, the larger droplet sizes characteristic of conventional emulsions contribute to uneven retention on crop surfaces. This results in areas of reduced coverage and increased susceptibility to runoff, particularly on hydrophobic leaf surfaces.

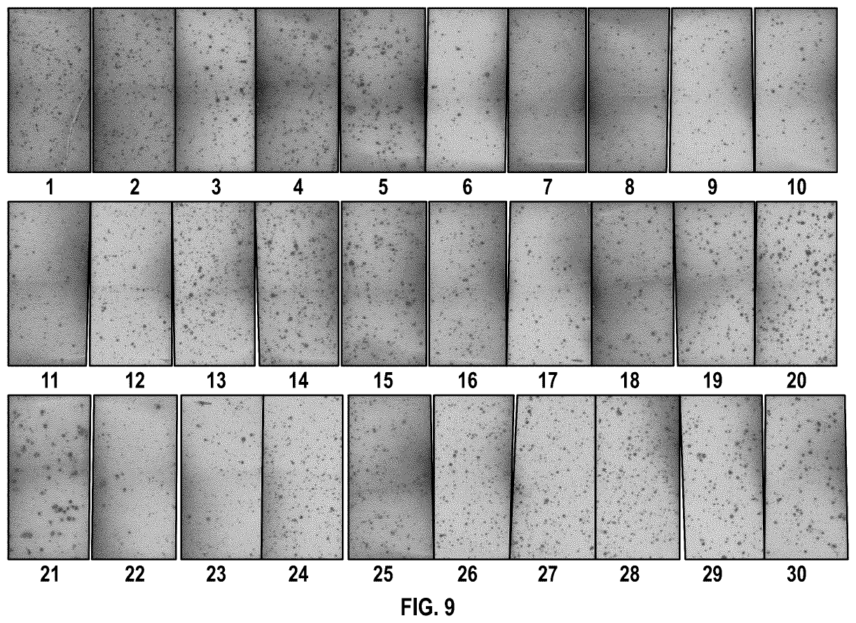

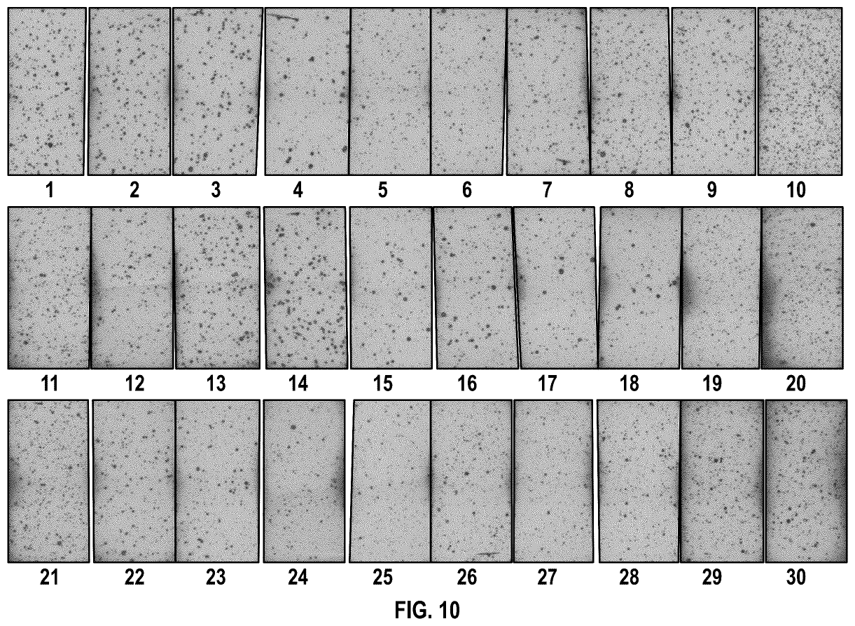

FIG. 9 and FIG. 10 each illustrate photomicrographic analyses of hydrosensitive card data (e.g., 1-30) demonstrating droplet deposition characteristics achieved through application of the supercritical nano-emulsion formulation. The analytical field displays systematic droplet distribution patterns manifested through localized staining on the hydrosensitive substrate (e.g., crop surface), wherein the chromatic differentiation between the crop surface and the impact-initiated droplet sites enables quantification of spatial distribution parameters.

The patterns demonstrate consistent droplet allocation achieving a mean density of 60 droplets per square centimeter across the evaluated zones. Individual droplet manifestations exhibit controlled dimensional parameters, validating maintenance of targeted particle size distributions throughout the application sequence.

The sequential evaluation zones validate stability of application parameters across the treatment field, with minimal variation in droplet density or distribution characteristics between measurement locations. The documented coverage patterns provide empirical validation of enhanced surface interaction dynamics achieved through the supercritical nano-emulsion architecture, demonstrating superior uniformity compared to conventional formulation methodologies.

The consistency of droplet distribution characteristics across the analytical field confirms maintenance of optimal application parameters throughout the deployment sequence, thereby validating the efficacy of the ultrasonic processing methodology in achieving targeted atomization characteristics. The hydrosensitive card analysis provides quantitative verification of uniform coverage parameters essential for optimal agricultural spray performance.

The formulations disclosed herein demonstrate versatility when combined with common agricultural chemicals. A smaller and more uniform size of oil droplets ensures better adhesion with leaves and more uniform distribution of active ingredients. Extensive compatibility testing with widely-used agrochemicals from major manufacturers confirmed that the formulation maintains its stability and performance characteristics when mixed with these products. This compatibility enables efficient integration into existing agricultural spray programs without requiring separate application cycles. The formulation's stability and effectiveness remain consistent across various mixing ratios and chemical combinations, allowing flexible adaptation to specific crop protection needs.

The resulting nano-emulsion exhibits distinctive physical and performance properties. Field trials conducted across multiple countries and crops over six growing seasons demonstrate enhanced residence time and agricultural impact compared to existing market products. The improved performance derives from superior wetting properties attributable to nano-scale droplet size and the presence of ethoxylated lauric alcohol. The isoparaffinic structure provides lower surface tension compared to linear isomers, promoting film formation and leaf surface coverage. These characteristics enable complete leaf coverage and enhanced retention, even under adverse weather conditions including heavy rainfall.

Environmental and safety testing conducted under standardized protocols confirms favorable characteristics. Biodegradability testing according to Organization for Economic Co-operation and Development (OECD) Method 301B, demonstrates biodegradability of the product. Ecotoxicity testing shows minimal environmental impact, with high lethal dose values for bees, fish, Lemna gibba, and Daphnia magna. Safety evaluation reveals no eye or skin irritation potential, no skin sensitization, and high lethal dose values for oral, inhalation, and dermal exposure routes.

The nano-emulsion maintains stability characteristics across various conditions. The composition appears white with a creamy texture and demonstrates stability for 6, 9, and 12 months under ambient temperature conditions including normal daily temperature fluctuations. Cold stability testing according to Method 39.3 of the Collaborative International Pesticides Analytical Council (CIPAC MT 39.3) confirms stability at 0 degrees Celsius for 7 days without separation.

Biodegradation studies reveal significant environmental advantages compared to conventional agricultural oils. The formulation achieves complete biodegradation within approximately 90 days under standard test conditions, compared to typical degradation periods of two years or more for conventional agricultural spray oils. This rapid biodegradation characteristic reduces environmental impact while maintaining required residual activity for crop protection.

Physical characterization includes multiple analytical parameters. The Brix grade (degrees Brix) indicates mixing effectiveness and correlates with droplet size reduction. Ultrasonic processing achieves mean droplet sizes of approximately 20 nanometers. Dynamic viscosity provides an additional control parameter, increasing with decreased droplet size due to enhanced surface area effects. Both Brix grade and viscosity measurements demonstrate dependence on oil concentration in the final composition.

### Methods of Production

A high-level process flow for the production of a stable nano-emulsion comprising five sequential stages. In a first step, raw material receipt and inspection, incoming materials are subjected to quality control measures to verify compliance with predefined specifications, ensuring their suitability for processing. Following inspection, a second step involves storing the raw materials in dedicated facilities under controlled environmental conditions, including temperature, humidity, and containment parameters, to maintain their integrity. A third step encompasses the mixing and emulsion process, where the core manufacturing occurs through precise control of component addition sequences, agitation conditions, and ultrasonic processing parameters to achieve the desired nano-emulsion properties. Once processed, the finished product is stored under monitored conditions in a fourth step to preserve its stability and quality pending final quality assurance testing. In a fifth step, the product is packaged and dispatched according to customer requirements, completing the production process.

A process for producing a stable agricultural spray oil nano-emulsion involves careful control over component selection, processing conditions, and energy application to achieve the desired emulsion characteristics. The process begins by combining treated water, an isoparaffinic hydrocarbon oil, and a surfactant mixture in a mixing chamber to form a pre-emulsion. The surfactant mixture includes a fatty alcohol ethoxylate with seven to nine ethylene oxide units, providing a hydrophilic-lipophilic balance (HLB) value between 12 and 14, sorbitan monooleate with an HLB value in the range of 4 to 5, and polyoxyethylene twenty sorbitan monolaurate, which contributes a high HLB value of 16 to 17. The selection of surfactants with complementary HLB values promotes effective emulsification and stability of the oil-in-water system.

Once the pre-emulsion is formed, it is subjected to ultrasonic energy under controlled conditions. The ultrasonic frequency is maintained at approximately 20 kilohertz, with a sonic wave power density exceeding 10 watts per liter, and a total energy input in the range of 0.5 to 50 watt-hours per liter. These energy parameters facilitate nano-scale droplet formation while enabling efficient droplet size reduction. At the same time, the temperature of the mixture is maintained below 45 degrees Celsius using a cooling system, as this threshold avoids thermal degradation of the surfactants and the isoparaffinic oil, preserving the properties of the resulting nano-emulsion.

The ultrasonic processing continues until a stable nano-emulsion is produced, characterized by a mean droplet size in the range of 10 to 100 nanometers and a monomodal droplet size distribution. This narrow and uniform droplet size supports emulsion stability and performance, particularly for agricultural spray applications. The resulting nano-emulsion resists phase separation under ambient conditions, ensuring extended shelf life and consistent behavior during field application. By balancing the surfactant composition, energy input, and thermal regulation, the process provides a stable nano-emulsion optimized for agricultural use.

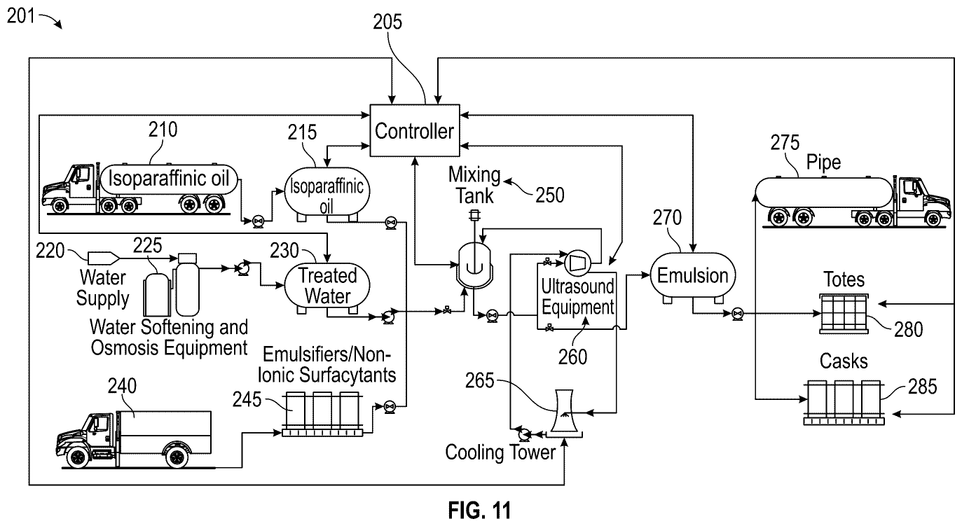

FIG. 11 illustrates a schematic comprising three parallel raw material inputs that converge in a central processing system 201. The first stream involves isoparaffinic oil handling, starting with tanker delivery 210, which uses positive displacement pumps to transfer oil into bulk storage tank 215. Bulk storage tank 215 is equipped with level sensors, temperature monitoring, and nitrogen blanketing to preserve oil quality during storage, all of which can be monitored and controlled by controller 205.

The second input includes water treatment, beginning with a municipal water supply 220. The water is processed through softening and reverse osmosis equipment 225 to achieve a conductivity below 10 microsiemens per centimeter. Ion exchange removes hardness, and pH is adjusted to 5.0-6.5 before the treated water is transferred to storage tank 230. Storage tank 230 incorporates continuous monitoring of pH, conductivity, and water quality parameters, all of which can be monitored and controlled by controller 205.

The third input includes surfactant delivery 240, where materials are transferred to dedicated storage vessels 245. These vessels maintain separate storage for different surfactants, including alcohol ethoxylates, sorbitan esters, and polysorbates, to prevent cross-contamination. Storage vessels 245 feature heating elements for surfactants requiring elevated temperatures to maintain fluidity.

The raw materials from these streams are combined in mixing tank 250 to create a pre-emulsion. A pre-emulsion is a preliminary mixture comprising a dispersed phase, a continuous phase, surfactants, and optional additives, prepared prior to subjecting the mixture to ultrasonic processing. The dispersed phase typically includes oils, such as isoparaffinic oil, while the continuous phase includes treated water, often characterized by low conductivity, and a controlled pH surfactants, selected to reduce interfacial tension and promote emulsification, are uniformly distributed throughout the mixture. Additives, such as stabilizers or functional agents, may also be incorporated to enhance specific properties. The pre-emulsion is formed through mechanical agitation to achieve a coarse dispersion, establishing the necessary conditions for subsequent ultrasonic refinement.

The mixing tank 250 employs variable speed mixing to disperse the materials, and a dedicated pump loop circulates the mixture through ultrasound equipment 260. This ultrasonic processor operates at 1500-2000 watts and 20 kilohertz frequency, generating high-intensity mechanical waves to reduce droplet size to approximately 20 nanometers. Temperature control during ultrasonic processing is achieved using a cooling tower 265, which circulates water through a jacket surrounding the ultrasonic chamber to maintain process temperatures below 45 degrees Celsius.

Once the nano-emulsion achieves target specifications, it is transferred to storage tank 270. From there, distribution options include bulk transfer via tanker truck 275, intermediate totes 280 with a 1000-liter capacity, or smaller 200-liter casks 285.

In general, control valves and positive displacement pumps regulate material flow throughout the system 201. The controller 205 oversees and manages all process parameters within the manufacturing system through a distributed control network. It monitors flows, temperatures, pressures, levels, and ultrasonic processing conditions. For the isoparaffinic oil, controller 205 ensures that level sensors, temperature monitors, and nitrogen blanketing in storage tank 215 operate as required. Similarly, it directs the water treatment system at supply point 220, including ion exchange, reverse osmosis, and pH adjustment, and continuously verifies water quality parameters in storage tank 230. In the surfactant handling system, controller 205 manages the heating elements in storage vessels 245.

In the central processing system, controller 205 regulates the sequence of raw material addition, the operation of variable speed mixing in tank 250, and the ultrasonic power input and energy totalization in ultrasound equipment 260. During ultrasonic processing, it manages the cooling water flow rates and monitors process temperatures. Additionally, controller 205 directs valve positions and pump operations, ensuring consistent material flow between vessels, from initial raw material handling to final product distribution.

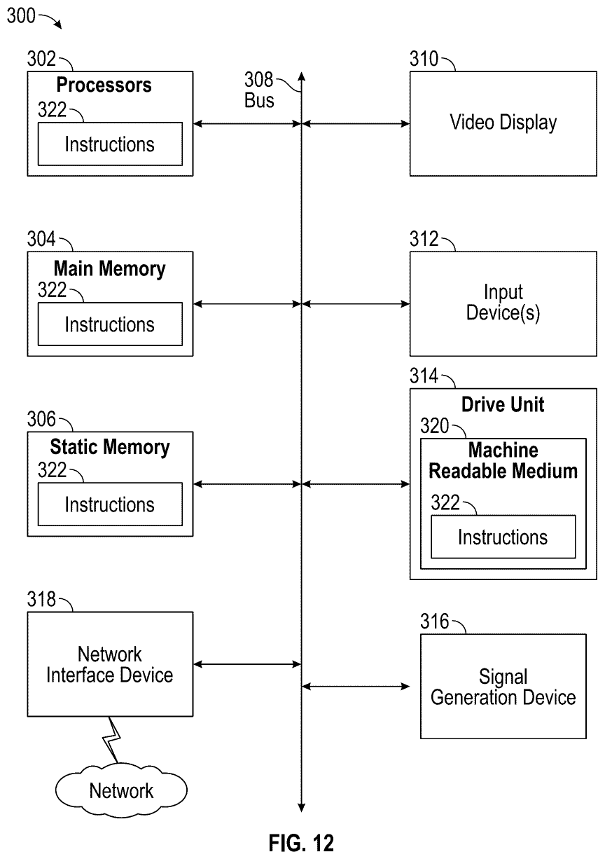

FIG. 12 is a schematic representation of an example computer system 300 that is an example implementation of the controller 205 shown in FIG. 11. The computer system 300 includes a processor and associated memory that store and execute instructions for regulating parameters such as ultrasonic energy input, mixing speeds, temperature control, and material flow rates, as detailed in the specification. The computer system 300 communicates with devices such as ultrasonic processors, mixing tanks, and cooling systems to ensure precise application of ultrasonic energy, maintaining critical droplet sizes below 100 nanometers. The computer system 300 can also manage water treatment and material storage, ensuring conditions like pH, conductivity, and surfactant ratios are maintained within optimal ranges.

The computer system 300 implements closed-loop control of the ultrasonic processing parameters through continuous monitoring of process variables. A series of sensors provides real-time feedback on critical parameters including temperature, pressure, flow rate, and power consumption. The processor 302 executes algorithms that adjust ultrasonic power output between 1500 and 2000 watts to maintain optimal cavitation conditions while preventing thermal degradation of the emulsion components. Temperature control is achieved through modulation of coolant flow through the cooling jacket, with the control system maintaining process temperatures below 45 degrees Celsius.

The ultrasonic processing control system monitors the cumulative energy input, calculated as the time integral of instantaneous power, to ensure delivery of 0.5 to 50 watt-hours per liter of emulsion. The processor 302 adjusts the duty cycle of the ultrasonic generator to compensate for variations in acoustic coupling efficiency and mechanical load. Automatic shutdown sequences are initiated when either the target energy input is achieved or if process parameters exceed predetermined safety limits. The control system maintains records of all processing parameters for quality assurance and regulatory compliance.

Material flow through the ultrasonic processor is regulated by the computer system 300 through control of positive displacement pump speeds and valve positions. Flow rates are maintained at 20 gallons per minute (other emulsions may include different flow rates and operating parameter) to ensure consistent residence time in the ultrasonic field. The system implements feed-forward control algorithms that adjust ultrasonic power levels in anticipation of changes in material properties or flow conditions. This predictive control strategy helps maintain consistent droplet size distribution throughout the batch processing cycle.

In more detail, the computer system 300 operates as a standalone device or may be connected (e.g., networked) to other machines. In a networked deployment, the computer system 300 may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 300 includes a processor or multiple processor(s) 302 (e.g., a central processing unit (CPU), a graphics processing unit (GPU), or both), and a main memory 304 and static memory 306, which communicate with each other via a bus 308. The computer system 300 may further include a video display 310 (e.g., a liquid crystal display (LCD)). The computer system 300 may also include an alpha-numeric input device(s) 312 (e.g., a keyboard), a cursor control device (e.g., a mouse), a voice recognition or biometric verification unit (not shown), a drive unit 314 (also referred to as disk drive unit), a signal generation device 316 (e.g., a speaker), and a network interface device 318. The computer system 300 may further include a data encryption module (not shown) to encrypt data.

The drive unit 314 includes a computer or machine-readable medium 320 on which is stored one or more sets of instructions and data structures (e.g., instructions 322) embodying or utilizing any one or more of the methodologies or functions described herein. The instructions 322 may also reside, completely or at least partially, within the main memory 304 and/or within the processor(s) 302 during execution thereof by the computer system 300. The main memory 304 and the processor(s) 302 may also constitute machine-readable media.

The instructions 322 may further be transmitted or received over a network via the network interface device 318 utilizing any one of a number of well-known transfer protocols (e.g., Hyper Text Transfer Protocol (HTTP)). While the machine-readable medium 320 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

### Example Formulations and Examples

In embodiments, specific formulations demonstrate the preparation and properties of the nano-emulsion composition. The following examples illustrate but do not limit the scope of the disclosure and can be permuted by one of ordinary skill in the art.

In a first embodiment, the process begins with water treatment to achieve 0 milligrams per liter hardness, conductivity of 0 microsiemens per centimeter, and pH value of 5.62. The mixing tank receives 480 kilograms of the treated water. Agitation begins at 33 revolutions per minute and continues without interruption throughout the entire process until the tank is emptied. Following water addition, 480 kilograms of isoparaffinic oil enters the mixing tank. The surfactant addition sequence begins with 20 kilograms of previously melted ethoxylated lauric alcohol (ALE 9M), followed by 20 kilograms of sorbitan monooleate (SPAN 80™).

The recirculation process initiates by opening the valve to the ultrasonic chamber. The connected pump activates at a flow rate of 20 gallons per minute. The ultrasonic processor operates at 1800 watts power input. Concurrent with ultrasonic processing, the cooling jacket system activates to maintain temperature control. These processing conditions continue until achieving a total energy input of 8 watt-hours per liter. Upon reaching the target energy input, the ultrasonic processor shuts down, followed by deactivation of the pump and closure of the corresponding valve. The completed nano-emulsion transfers to storage containers pending quality control approval. The resulting composition exhibits a Brix grade of 30.8%, density of 0.914 grams per milliliter, viscosity of 19.7 centipoise measured at 25 degrees Celsius, and refractive index of 1.3827.

The results of Example 1, as presented in Table 3, demonstrate the formulation's physical properties, including a Brix grade of 30.8%, a density of 0.914 g/mL, and a viscosity of 19.7 cP at 25° C. These properties validate the nano-emulsion's stability and uniformity under standard conditions.

TABLE 3

| Brix grade | Density | Viscosity | Refraction |
|---|---|---|---|
| (20° C.) | (20° C.) | (25° C.) | index |
| 30.8% | 0.914 g/mL | 19.7 cP | 1.3827 |

In another embodiment, the process begins with water treatment to achieve specific parameters: 0 milligrams per liter hardness, conductivity of 4 microsiemens per centimeter, and pH value of 6.12. The mixing tank receives 630 kilograms of the treated water. Agitation begins at 30 revolutions per minute and continues without interruption throughout the entire process until the tank is emptied. Following water addition, 330 kilograms of isoparaffinic oil enters the mixing tank. The surfactant addition sequence begins with 20 kilograms of polysorbate 20 (Tween 20™), followed by 20 kilograms of sorbitan monooleate (SPAN 80 ™).

The recirculation process initiates by opening the valve to the ultrasonic chamber. The connected pump activates at a flow rate of 20 gallons per minute. The ultrasonic processor operates at 1800 watts power input. Concurrent with ultrasonic processing, the cooling jacket system activates to maintain temperature control. These processing conditions continue until achieving a total energy input of 10 watt-hours per liter. Upon reaching the target energy input, the ultrasonic processor shuts down, followed by deactivation of the pump and closure of the corresponding valve. The completed nano-emulsion transfers to storage containers pending quality control approval. The resulting composition exhibits a Brix grade of 30.4%, density of 0.939 grams per milliliter, and viscosity of 5.6 centipoise measured at 25 degrees Celsius, as illustrated in Table 4.

TABLE 4

| Brix grade | Density | Viscosity | Refraction |
|---|---|---|---|
| (20° C.) | (20° C.) | (25° C.) | index |
| 30.4% | 0.939 g/mL | 5.6 cP | 1.3820 |

In a third embodiment, the process begins with water treatment to achieve 0 milligrams per liter hardness, conductivity of six microsiemens per centimeter, and pH value of 5.34. The mixing tank receives 610 kilograms of the treated water. Agitation begins at 36 revolutions per minute and continues without interruption throughout the entire process until the tank is emptied. Following water addition, 330 kilograms of isoparaffinic oil enters the mixing tank. The surfactant addition sequence begins with 20 kilograms of previously melted ethoxylated lauric alcohol (ALE 9M™), followed by 20 kilograms of sorbitan monooleate (SPAN 80™), and 20 kilograms of polysorbate 20 (Tween 20™).

The recirculation process initiates by opening the valve to the ultrasonic chamber. The connected pump activates at a flow rate of 20 gallons per minute. The ultrasonic processor operates at 1800 watts power input. Concurrent with ultrasonic processing, the cooling jacket system activates to maintain temperature control. These processing conditions continue until achieving a total energy input of 10 watt-hours per liter. Upon reaching the target energy input, the ultrasonic processor shuts down, followed by deactivation of the pump and closure of the corresponding valve. The completed nano-emulsion transfers to storage containers pending quality control approval. The resulting composition exhibits a Brix grade of 42.0%, density of 0.919 grams per milliliter, and viscosity of 26.6 centipoise measured at 25 degrees Celsius, as illustrated in Table 5.

TABLE 5

| Brix grade | Density | Viscosity | Refraction |
|---|---|---|---|
| (20° C.) | (20° C.) | (25° C.) | index |
| 42.0% | 0.919 g/mL | 26.6 cP | 1.4038 |

These embodiments demonstrate that various combinations of the disclosed non-ionic surfactants produce stable nano-emulsions suitable for agricultural applications. The formulation parameters can be adjusted within the disclosed ranges to optimize performance for specific end-use requirements while maintaining the essential stability and functional characteristics of the nano-emulsion system.

The ultrasound-assisted oil-in-water nano-emulsion technology described is particularly effective for treating banana plants against pests and diseases. The nano-sized droplets enhance coverage and adhesion to the plant's surface, creating a protective film that resists environmental degradation, including heavy rain. This formulation is designed to integrate seamlessly with existing agricultural practices, offering an efficient, biodegradable alternative to conventional mineral oils. It is particularly effective in combating fungal infestations and pests prevalent in banana cultivation, enhancing crop safety and yield while reducing environmental impact.

This nano-emulsion technology, based on a stable oil-in-water formulation with ultrasound-assisted processing, is broadly applicable to any plant or leaf treatment. The technology achieves superior droplet uniformity and adhesion, maximizing the efficacy of protective films. It can be tailored to various crops, improving pest and disease management while maintaining plant health and minimizing environmental harm. The ultrasound-assisted oil-in-water nano-emulsion technology extends beyond agricultural uses and offers innovative solutions in multiple industries. In pharmaceuticals, it can create stable drug delivery systems with improved bioavailability. In cosmetics, it enables the development of skincare products with enhanced texture, absorption, and stability. The food and beverage industry can utilize this technology to improve the blending and longevity of oil-based components in liquid products, while industrial applications benefit from finely dispersed lubricants for enhanced performance and efficiency.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. An agricultural spray formulation, comprising:
an oil phase, the oil phase further comprising isoparaffinic hydrocarbon oil, substantially free of naphthenic compounds;
an aqueous phase, the aqueous phase further comprising treated water;
a surfactant phase, the surfactant phase further comprising:
1.0 to 1.5 percent by mass of a fatty alcohol ethoxylate, comprising lauric alcohol ethoxylates containing seven to nine ethylene oxide units, with a hydrophilic-lipophilic balance value of 12 to 14;
1.0 to 1.5 percent by mass of sorbitan monooleate with a hydrophilic-lipophilic balance value of 4 to 5, and
1.0 to 1.5 percent by mass of polyoxyethylene twenty sorbitan monolaurate, with a hydrophilic-lipophilic balance value of 16 to 17; and
the agricultural spray formulation is a nano-emulsion having a mean droplet size of 10 to 100 nanometers, with a monomodal droplet size distribution, and demonstrating stability against phase separation under ambient conditions.

2. The agricultural spray formulation of claim 1, wherein the isoparaffinic hydrocarbon oil comprises 30.0 to 35.0 percent by mass of the formulation.

3. The agricultural spray formulation of claim 1, wherein the aqueous phase comprises 60.0 to 70.0 percent by mass of the formulation.

4. The agricultural spray formulation of claim 1, wherein the treated water of the aqueous phase has a conductivity of less than 10 microsiemens per centimeter and a pH between 5.0 and 6.5.

5. The agricultural spray formulation of claim 1, wherein the nano-emulsion comprises:
a first rheological state comprising non-Newtonian shear-thinning behavior when the hydrocarbon oil exceeds 20 percent by mass, providing storage stability;
a second rheological state comprising Newtonian behavior when diluted to less than 10 percent by mass hydrocarbon oil content, enabling uniform spray distribution; and
a third rheological state comprising thixotropic properties upon water evaporation after application, enhancing retention on plant surfaces.

6. The agricultural spray formulation of claim 1, wherein the nano-emulsion demonstrates a droplet coverage density of at least 60 droplets per square centimeter when applied to crop surfaces.

7. The agricultural spray formulation of claim 1, wherein the nano-emulsion exhibits a Brix grade of 30.0 to 42.0 percent at 20 degrees Celsius.

8. The agricultural spray formulation of claim 1, further comprising 0.1 to 10.0 percent by mass of an agricultural active ingredient selected insecticides and/or fungicides.

9. A process for preparing an agricultural spray oil nano-emulsion, comprising:
combining treated water, an isoparaffinic hydrocarbon oil, and a surfactant mixture in a mixing chamber to form a pre-emulsion, the surfactant mixture further comprising:
a fatty alcohol ethoxylate containing seven to nine ethylene oxide units with a hydrophilic-lipophilic balance value of 12 to 14,
sorbitan monooleate with a hydrophilic-lipophilic balance value of 4 to 5, and
polyoxyethylene twenty sorbitan monolaurate with a hydrophilic-lipophilic balance value of 16 to 17;
subjecting the pre-emulsion to ultrasonic energy under the following conditions:
a frequency of approximately 20 kilohertz,
a sonic wave power density in excess of 10 watt per liter,
a total energy input of 0.5 to 50 watt-hours per liter, and
a processing temperature maintained below 45 degrees Celsius; and
continuing ultrasonic processing until a nano-emulsion is formed with a mean droplet size of 10 to 100 nanometers and a monomodal droplet size distribution, and resisting phase separation under ambient conditions.

10. The process of claim 9, wherein the treated water has a conductivity of less than 10 microsiemens per centimeter and a pH between 5.0 and 6.5.

11. The process of claim 9, wherein the nano-emulsion comprises 30.0 to 35.0 percent by mass of the isoparaffinic hydrocarbon oil.

12. The process of claim 9, wherein the nano-emulsion comprises 60.0 to 70.0 percent by mass of the treated water.

13. The process of claim 9, wherein the nano-emulsion achieves comparable or improved pest and disease control efficacy while including at least 30 percent less oil per hectare compared to emulsions prepared without ultrasonic processing.

14. The process of claim 9, wherein the nano-emulsion comprises:
a concentrated state having non-Newtonian rheological properties with a viscosity between 19.0 and 27.0 centipoise at 25 degrees Celsius;
a diluted state for application having substantially Newtonian rheological properties with a viscosity between 5.0 and 8.0 centipoise at 25 degrees Celsius; and
wherein the nano-emulsion transitions from a Newtonian diluted state to a thixotropic state upon partial water evaporation during the forming of a uniform coating on a crop surface.

15. The process of claim 14, wherein the nano-emulsion demonstrates a droplet coverage density of at least 60 droplets per square centimeter when applied to the crop surface.

16. A method of using an agricultural spray oil nano-emulsion for crop protection, comprising:
obtaining a nano-emulsion, the nano-emulsion further comprising:
an oil phase, the oil phase further comprising an isoparaffinic hydrocarbon oil;
an aqueous phase, the aqueous phase further comprising water;
a surfactant mixture, the surfactant mixture further comprising:
a fatty alcohol ethoxylate containing seven to nine ethylene oxide units,
sorbitan monooleate, and
polyoxyethylene twenty sorbitan monolaurate, the nano-emulsion has a mean droplet size of 10 to 100 nanometers and a monomodal droplet size distribution;
applying the nano-emulsion to crops at an application rate of 10 to 30 liters per hectare using a spraying device configured to deliver droplets with a size distribution between 10 and 100 nanometers; and
forming a uniform coating on crop surfaces.

17. The method of claim 16, wherein the forming of the uniform coating comprises:
applying the nano-emulsion in a Newtonian state having a viscosity between 5.0 and 8.0 centipoise;
allowing partial water evaporation during droplet transit to induce shear-thinning behavior;
achieving surface adhesion through transformation to a thixotropic state upon plant contact; and wherein the thixotropic state provides:
resistance to rainfall wash-off;
enhanced spreading across hydrophobic leaf surfaces; and
mechanical stability against wind-induced removal.

18. The method of claim 16, wherein the nano-emulsion further comprises at least one of insecticides and/or fungicides.

19. The method of claim 16, wherein the uniform coating demonstrates a droplet coverage density of at least 60 droplets per square centimeter.

20. The method of claim 16, wherein the nano-emulsion achieves comparable or improved pest and disease control efficacy while including at least 30 percent less oil per hectare compared to applications prepared without ultrasonic processing.
